(19) United States
(12) Patent Application Publication
(10) Pub. No.: US 2007/0021532 A1
(43) Pub. Date: Jan. 25, 2007

(54) Coating method for ship-bottom paint

(76) Inventor: Sang-woon Kwak, Seoul (KR)

Correspondence Address: CANTOR COLBURN, LLP, 55 GRIFFIN ROAD SOUTH, BLOOMFIELD, CT, 06002, US

(21) Appl. No.: 10/575,652

(22) PCT Filed: Oct. 15, 2004
(86) PCT No.: PCT/KR04/02638

§ 371 Date: Apr. 14, 2006

(30) Foreign Application Priority Data
Oct. 15, 2003 (KR) 10-2003-0071950

(51) Int. Cl. C09J 4/00

(52) U.S. Cl. 523/177; 524/494; 428/323

(57) ABSTRACT

The present invention relates to a method for coating a ship-bottom paint and more particularly, to a method for coating a ship-bottom paint comprising the steps of: coating a coating composition comprising a liquid type room temperature curable organic resin, and 10 to 400 weight parts, based on 100 weight parts of the liquid type room temperature curable organic resin, of glass powder on the bottom of a ship; and spraying glass beads on the surface of the resin before the resin of the coating composition is cured, followed by curing. The method for coating a ship-bottom paint according to the present invention can effectively prevent attachment of marine organisms on the ship bottom while simultaneously providing excellent abrasion resistance, durability, impact resistance and scratch resistance. Also, the coating can be readily constructed and reduce surface resistance of a large vessel during sailing, improving economical efficiency.

### Technical Field

The present invention relates to a method for coating a ship-bottom paint and more particularly, a coating composition for a ship bottom paint which can effectively prevent attachment of marine organisms on the ship bottom while simultaneously providing excellent dispersion stability, abrasion resistance, durability, impact resistance and scratch resistance, can be readily constructed and reduce surface resistance of a large vessel.

### Background Art

The bottom of ships is always in contact with seawater. Specially, in case of a large vessel sailing the sea, many fouling organisms such as shellfishes and seaweeds attach to the ship bottom and breed. These fouling organisms cause an increase in hydrodynamic resistance and bring about undesirable ship conditions such as deteriorating ship functions by damaging coating parts of the ship surface. Therefore, the ship bottom of a common ship is newly coated annually or biennially.

In order to prevent the attachment and propagation of seawater and fresh-water unwanted organisms, anti-fouling agents such as copper oxide and organotin compounds have been conventionally used and at present are being used widely.

However, heavy metals and toxic elements recently raise social problems such as pollution of the rivers and seas and infliction of injury upon human beings by intermediation of fish. Therefore, the copper oxide and organotin compounds should be limitedly used as an anti-fouling agent.

Japanese Patent Laid-Open Publication No. Sho 53-9320 and Japanese Patent Laid-Open Publication No. Sho 55-40608 disclose N-aryl maleimide compounds as a non-heavy metal anti-fouling agent. However, the non-heavy metal anti-fouling agent shows significantly inferior anti-fouling effect as compared to organotin compounds and some of the non-heavy metal anti-fouling agent having relatively high anti-fouling effect have problems associated with remaining in shellfishes. Also, N-aryl maleimide shows poor stability in solvents. Further, it shows poor storage stability since effective ingredients are often crystallized when it is formulated in an anti-fouling paint.

Therefore, there is an urgent need for a coating composition for a ship bottom paint having excellent preventive effect on marine attaching organisms and excellent stability and dispersion stability against shellfishes.

### DISCLOSURE OF INVENTION

Technical Problem

Therefore, in order to solve the problems involved in the prior art, it is an object of the present invention to provide a method for coating a ship-bottom paint that can effectively prevent attachment of marine organisms including shellfishes to the ship bottom and a ship having the ship bottom coated by the method.

It is another object of the present invention to provide a method for coating a ship-bottom paint which has excellent abrasion resistance, durability, impact resistance and scratch resistance, be readily constructed and reduce surface resistance of a large vessel, improving economical efficiency, and a ship having the ship bottom coated by the method.

Technical Solution

In order to achieve the above objects, according to the present invention, there is provided a method for coating a ship-bottom paint comprising the steps of: coating a coating composition comprising a liquid type room temperature curable organic resin, and 10 to 400 weight parts, based on 100 weight parts of the liquid type room temperature curable organic resin, of glass powder on the bottom of a ship: and spraying glass beads on the surface of the resin before the resin of the coating composition is cured, followed by curing.

Also, according to the present invention, there is provided a ship having the ship bottom coated by the method for coating a ship-bottom paint by the method as described above.

Advantageous Effect

The method for coating a ship-bottom paint according to the present invention can effectively prevent attachment of marine organisms on the ship bottom while simultaneously providing excellent abrasion resistance, durability, impact resistance and scratch resistance. Also, the coating can be readily constructed and reduce surface resistance of a large vessel, improving economical efficiency.

### BRIEF DESCRIPTION OF DRAWINGS

Further objects and advantages of the invention can be more fully understood from the following detailed description taken in conjunction with the accompanying drawings in which:

FIG. 1 is a photograph of the specimen coated in Example 2 according to the present invention after storage for 12 months following the anti-fouling property test; and

FIG. 2 is a photograph of the specimen coated in Comparative Example 3 after storage for 12 months following the anti-fouling property test.

### MODE FOR CARRYING OUT THE INVENTION

Now, the present invention will be described in detail.

The method for coating a ship-bottom paint according to the present invention comprises the steps of coating a coating composition comprising a liquid type room temperature curable organic resin and glass powder on the bottom of a ship and spraying glass beads on the top of the resin coating layer before the resin of the coating composition is cured, followed by curing.

The liquid type room temperature curable organic resins used according to the present invention include those used in the prior art, such as epoxy based, acryl based, urethane based, alkyd based, polyester based or polyvinylchloride based resins. The epoxy-based resin is preferably a non-solvent or solvent-dilution type epoxy resin of diglycidyl type and triglycidyl type having a molecular weight in the range of 350 to 3,000 MW. The acryl based resin is preferably a solvent type acryl urethane having a methacrylic acid derivative as a main component, water base acryl hydrosol, emulsion non-solvent type acryl silane or UV curable acryl. The alkyd based resin is preferably an alkyd resin in the form of a paint modified by an ester compound of a polybasic acid and a polyol, an alkyd resin modified by rosin, phenol, epoxy, vinyl styrene monomer, isocyanate or silicon. The polyvinylchloride based resin is preferably a plastic sol liquid resin of PVC type.

These resins act as a binder of the coating composition and provide acid resistance and alkali resistance. In some cases, a curing agent may be used for curing of the resins. Also, a curing accelerator may be used to control the curing rate. Of course, the selection of such curing agent and curing accelerator depends on type and amount of the used resin.

If the liquid type room temperature curable organic resin is used in a too small amount, its effect is feeble. If it is used in an excessively large amount, the content of the glass powder is reduced, causing deterioration in strength and general properties.

The glass powder used according to the present invention is mixed into the resin to increase viscosity of the coating composition. Also, it fills in pores of the resin after curing, whereby it enhances impact resistance and strengthens surface hardness, improving abrasion resistance, durability and scratch resistance.

The glass powder may be used in various particle shapes and particle sizes. The particles of the glass powder are obtained by pulverizing common glass. The glass composition is not particularly limited as long as the components are compatible with the resin, including A, C, E and alkali resistant glass powder compositions. In particular, the glass powder has preferably a particle size of 10 μm to 1 mm for readiness for the coating process and properties.

The glass powder is preferably contained in an amount of 10 to 400 weight parts, more preferably in an amount of 50 to 100 weight parts, based on 100 weight parts of the resin solid content in the composition. If the content is less than 10 weight parts, the viscosity of the coating composition is lowered and contraction and expansion are increased after curing. If content exceed 400 weight parts, the viscosity is excessively increased and the resin content is lowered, reducing strength. In addition, glass beads to be sprayed and fixed on the resin surface may fall off.

Also, as the method for coating a ship-bottom paint according to the present invention comprises the step of spraying and fixing the glass beads on the surface of the resin before the resin of the coating composition is cured, the glass beads usable in the present invention may have a spherical or elliptical shape, or any shape based on them. Also, the beads may have a size distribution of various sizes or a predetermined size. It is preferable to use spherical glass beads since they form protrusions (embossing) of a small size on the bottom of the ship, thereby reducing the surface resistance of the coating layer. More preferably, the glass beads have a particle size of 100 μm to 3 mm. If the glass beads have a particle size of less than 100 μm or more than 3 mm, the preventive effect on the attachment of marine organisms to the bottom of the ship may be deteriorated.

Preferably, the glass beads may be subjected to a water repellent treatment to reduce surface tension of the coating layer, thereby further reducing the attachment of marine organisms. Of course, the water repellent treatment may be performed by using one of the water repellent treatment methods known to the art. Particularly, the glass prepared according to the method disclosed in Korean Patent Application No. 10-1997-0002042, for example, may be used.

Also, the used amount of the glass beads, though not particularly limited, is preferably 10 to 200 weight parts, more preferably 50 to 100 weight parts, based on 100 weight parts of the resin solid content in the coating composition. When the content is in the foregoing range, optimum results may be obtained in properties of the coating part and the preventive effect on the attachment of marine organisms.

Also, the method for spraying the glass beads is not particularly limited as long as it can evenly spray the glass beads on the surface of the resin and fixedly insert a part of the sprayed glass beads into the resin while protruding a part of the glass beads out of the resin to form protrusions and preferably includes a method using a nozzle or sprayer.

Also, in the method for coating a ship-bottom paint according to the present invention, the coating composition may further comprise electro-conductive paint. In this case, the surface tension of the coating layer is reduced, thereby causing further inhibition of the attachment of marine organisms. Preferably, the electroconductive paint is sodium alginate or potassium alginate having a polar carboxyl group in the terminal and the used amount is 0.1 to 10 weight based on 100 weight parts of the resin solid content.

Also, according to the present invention, the coating composition may comprise glass fiber as needed. The presence of the glass fiber in the resin increases the tensile strength of the cured coating composition and prevents crack. The glass fiber is preferably long glass fiber of E glass composition. Fiber glass of alkali resistant composition may be used.

The glass fiber which can be used in the present invention include chopped fiber or milled fiber of glass fiber having a diameter of 10 to 20 μm, which are prepared by cutting the glass fiber in a uniform stand length or pulverizing the glass fiber in an average fiber length. Particularly, the chopped fiber is preferably cut in a fiber length of about 2 to 12 mm and the milled fiber has an average fiber length of 100 to 300 μm. Considering the reinforcement of tensile strength and dispersion of the resin mortar, it is preferable to use the milled fiber, possibly combined with chopped fiber.

The glass fiber is preferably contained in an amount of 1 to 50 weight parts based on 100 weight parts of the resin solid content in the composition. When the content of the glass fiber is in the foregoing range, it is possible to gain advantages in terms of tensile strength, durability and ease to process.

Also, the coating composition of the ship bottom paint according to the present invention may further comprise an additive such as a filler, a pigment, a viscoelasticity controller, an antifouling adjuvant, a thickener, an anti-sagging agent and the like.

Also, according to the method for coating a ship-bottom paint, the thickness of the coating layer may be appropriately adjusted considering the ship type, durability of the coating layer, and economical efficiency and preferably in the range of 500 to 7000 μm including the glass beads fixed on the surface of the resin.

Also, according to the present invention, there is provided a ship having a coating layer formed on the ship bottom by the method for coating a ship-bottom paint according to the present invention. The ship having the bottom coated according to the present invention can effectively prevent marine organisms from being attached on the ship bottom and shows excellent abrasion resistance, durability, impact resistance and scratch resistance. Also, by the protrusions on the surface of the coated ship bottom, the resistance against water of the ship during the sailing is considerably reduced and thus, the ship can sail at reduced fuel and power, providing economical efficiency.

Now, preferred embodiments are presented to help understanding of the present invention. However, the following examples are given only for illustrative purpose and the scope of the present invention is not limited thereto.

### EXAMPLE

### Example 1

1 kg of epoxy liquid resin (YD-128 produced by Kukdo Chemical Co., Ltd., Korea) as a room temperature curable liquid resin was mixed with 20 g of benzyl alcohol, 500 g of glass powder having an average particle size of 200 mesh and a specific gravity of 2.54 and 10 g of a pigment in a general mixer to prepare a coating composition. A sand blasted steel plate (15×30×0.2 cm) was coated with a urethane primer and dried for 2 days. A vinyl sealer was applied on the dried specimen and dried for 1 day. On the resulting specimen, the coating composition was applied to a thickness of about 600 μm and glass beads having an average particle size of 1 mm were sprayed before the resin was cured, followed by curing, so that a part of the sprayed beads were fixedly inserted in the resin while a part of the beads were protruded out of the resin to form protrusions. The dried specimen was placed under the water depth of 1.5 m in the coast of Bang-eo-jin, Ulsan (Korea) to examine anti-fouling property. The percentage of a fouled area over an effective test area was calculated and evaluated according to the following evaluation criteria. Here, the anti-fouling property was determined every 3 months. Also, the dried specimen was examined for abrasion resistance. The measurement was performed by the Tabor Abrasion Resistance Test Method, ASTM No. D1044. The result showing the most excellent property was given 5 scores, the result showing the middle property was given 3 scores and the result showing the poorest property was given 1 score based on the criteria in Table 1 and an average of 10 tests was recorded. The results are shown in Table 2.

TABLE 1

| | |
|---|---|
| Fouling level of less than 5% | Excellent |
| Fouling level of less than 20% | Good |
| Fouling level of less than 50% | Fair |
| Fouling level of less than 70% | Poor |
| Fouled by animal organisms | Very poor |

### Example 2

The same procedures as described in Example 1 were performed except for that water repellent glass having an average particle size of 1 mm was used in the coating composition of Example 1. The water repellent glass was the glass beads which had been subjected to the water repellent treatment described in Korean Patent Application No. 10-1997-0002042. The dried specimen was examined for anti-fouling property following the method described in Example 1 and the results are shown in Table 2.

### Example 3

The same procedures as described in Example 1 were performed except for that 100 g of sodium alginate was further used in the coating composition of Example 1. The dried specimen was examined for anti-fouling property following the method described in Example 1 and the results are shown in Table 2.

### Example 4

The same procedures as described in Example 1 were performed except for that 50 g of milled glass fiber having an average fiber thickness of 13.5 μm and an average fiber length of 300 μm was further used in the coating composition of Example 1. The dried specimen was examined for anti-fouling property following the method described in Example 1 and the results are shown in Table 2.

### Example 5

The same procedures as described in Example 1 were performed except for that glass beads, produced by Jisan Polymer Co., Ltd., having an average particle size of 0.1 mm was used in the coating composition of Example 1. The dried specimen was examined for anti-fouling property following the method described in Example 1 and the results are shown in Table 2.

### Example 6

The same procedures as described in Example 1 were performed except for that glass beads, produced by Jisan Polymer Co., Ltd., having an average particle size of 3 mm was used in the coating composition of Example 1. The dried specimen was examined for anti-fouling property following the method described in Example 1 and the results are shown in Table 2.

### Comparative Example 1

The same procedures as described in Example 1 were performed except for that copper oxide was used instead of the glass powder to prepare the coating composition. The dried specimen was examined for anti-fouling property following the method described in Example 1 and the results are shown in Table 2.

Comparative Example 2

The same procedures as described in Example 1 were performed except for that an organotin compound was used instead of the glass powder to prepare the coating composition. The dried specimen was examined for anti-fouling property following the method described in Example 1 and the results are shown in Table 2.

### Comparative Example 3

The same procedures as described in Example 1 were performed except for that an N-aryl maleimide compound was used instead of the glass powder to prepare the coating composition. The dried specimen was examined for anti-fouling property following the method described in Example 1 and the results are shown in Table 2.

TABLE 2

| | Anti-fouling property | | | | |
|---|---|---|---|---|---|
| | After 3 | After 6 | After 9 | After 12 | Abrasion |
| | months | months | months | months | resistance |
| Ex. 1 | Excellent | Excellent | Excellent | Good | 4.5 |
| Ex. 2 | Excellent | Excellent | Excellent | Excellent | 4.6 |
| Ex. 3 | Excellent | Excellent | Excellent | Excellent | 4.5 |
| Ex. 4 | Excellent | Excellent | Excellent | Good | 4.7 |
| Ex. 5 | Excellent | Excellent | Good | Fair | 4.5 |
| Ex. 6 | Excellent | Excellent | Good | Fair | 4.5 |
| Comp. | Excellent | Good | Poor | Very poor | 3.4 |
| Ex. 1 | | | | | |
| Comp. | Good | Fair | Poor | Very poor | 3.5 |
| Ex. 2 | | | | | |
| Comp. | Good | Poor | Very poor | Very poor | 3.3 |
| Ex. 3 | | | | | |

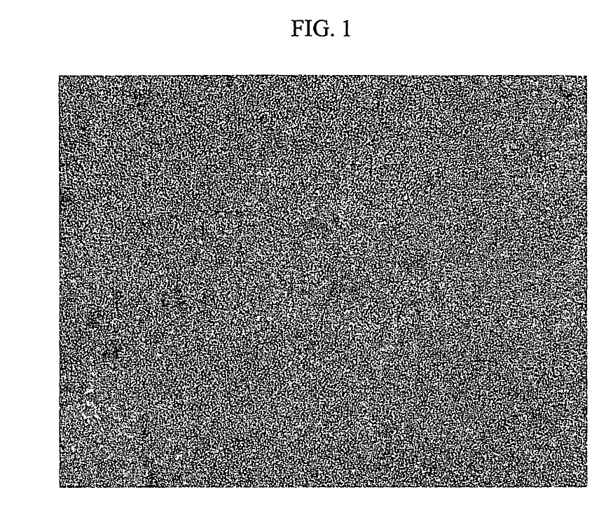

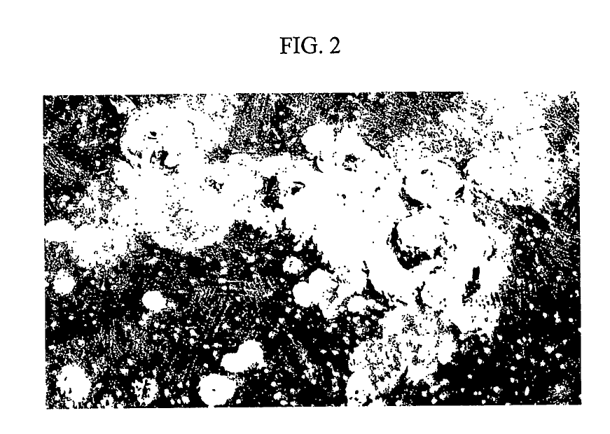

As can be seen from Table 2, it was noted that the methods for coating a ship-bottom paint of Example 1 to 6 according to the present invention was superior to the method of Comparative Example 1 to 3 using the conventional anti-fouling agents. Particularly, Example 2 using the water repellent glass and Example 3 using sodium alginate for surface treatment did now show little contamination on the surface, indicating excellent anti-fouling effect. FIG. 1 is a photograph of the specimen coated in Example 2according to the present invention after storage for 12months following the anti-fouling property test and FIG. 2 is a photograph of the specimen coated in Comparative Example 3 after storage for 12 months following the anti-fouling property test. As shown in the photographs, Example 2 showed excellent anti-fouling effect while Comparative Example 3 showed poor anti-fouling effect.

Also, when the used glass beads had an average particle size of a little smaller than the specified range (0.1 mm, Example 5) or a littler larger than the specified range (3 mm, Example 6), the anti-fouling effect was inferior than other examples from the time after 1 year, though it was excellent as compared to the conventional anti-fouling agents. Thus, it was noted that the glass beads used in the present invention should have a particle size of 0.1 to 3 mm for optimum anti-fouling effect.

### INDUSTRIAL APPLICABILITY

According to the method for coating a ship-bottom paint of the present invention, it is possible to effectively prevent attachment of marine organisms on the ship bottom while simultaneously providing excellent abrasion resistance, durability, impact resistance and scratch resistance. Also, the coating can be readily constructed and reduce surface resistance of a large vessel, improving economical efficiency.

What is claimed is:

1. A method for coating a ship-bottom paint comprising the steps of: coating a coating composition comprising a liquid type room temperature curable organic resin, and 10 to 400 weight parts, based on 100 weight parts of the liquid type room temperature curable organic resin, of glass powder on the bottom of a ship; and spraying glass beads on the surface of the resin before the resin of the coating composition is cured, followed by curing.

2. The method according to claim 1, in which the glass beads are water repellent treated glass beads.

3. The method according to claim 1, in which the glass beads have a particle size of 100 μm to 3 mm.

4. The method according to claim 1, in which the liquid type room temperature curable organic resin is at least one selected from the group consisting of epoxy based, acryl based, urethane based, alkyd based, polyester based and polyvinylchloride based resins.

5. The method according to claim 1, in which the glass powder has a particle size of 10 μm to 1 mm.

6. The method according to claim 1, in which the coating composition further comprises 0.1 to 10 weight parts of an electroconductive paint based on 100 weight parts of the resin solid content.

7. The method according to claim 1, in which the coating composition further comprises chopped fiber or milled fiber of glass fiber having a diameter of 10 to 20 μm, which are prepared by cutting the glass fiber in a uniform stand length or by pulverizing the glass fiber in an average fiber length in an amount of 1 to 50 weight parts based on 100 weight parts of the resin solid content in the composition.

8. The method according to claim 1, in which the coating composition further comprises at least one additive selected from the group consisting of a filler, a pigment, a viscoelasticity controller, an antifouling adjuvant, a thickener and an anti-sagging agent.

9. The method according to claim 1, in which the coating layer formed by spraying and curing on the ship bottom and comprising glass beads has a thickness of 500 to 7000 μm.

10. A ship having the ship bottom coated by the method for coating a ship-bottom paint according claims 1.
